(19) United States
(12) Patent Application Publication
(10) Pub. No.: US 2013/0141352 A1
(43) Pub. Date: Jun. 6, 2013

(54) ELECTRONIC DEVICE WITH TOUCH SENSITIVE DISPLAY AND TOUCH SENSITVIE DISPLAY UNLOCKING METHOD THEREOF

(71) Applicant: YAO-TING CHANG, Tu-Cheng (TW)

(72) Inventor: YAO-TING CHANG, Tu-Cheng (TW)

(73) Assignee: HON HAI PRECISION INDUSTRY CO., LTD., Tu-Cheng (TW)

(21) Appl. No.: 13/553,312

(22) Filed: Jul. 19, 2012

(30) Foreign Application Priority Data
Dec. 5, 2011 (TW) 100144736

(51) Int. Cl. G05B 19/00; G06F 3/041

(52) U.S. Cl. 345/173

(57) ABSTRACT

An electronic device includes a touch sensitive display configured to receive touches from a user and a processing unit. The processing unit controls a plurality of icons to be displayed when the touch sensitive display is in a locked state, detects whether a sequence of touches on certain icons of the plurality of icons matches one of at least one predefined sequences, and unlocks the touch sensitive display if the detection module detects that the sequence of touches matches a predefined sequence.

### BACKGROUND

1. Technical Field

The present disclosure relates to electronic devices and, particularly to an electronic device with touch sensitive display and a touch sensitive display unlocking method being used for unlocking the display of the electronic device.

2. Description of Related Art

When electronic devices with touch sensitive displays, such as mobile phones, Personal Digital Assistants (PDA), and the like, are carried in a pocket or in a handbag, the touch sensitive displays can be unintentionally touched by a user. In order to prevent the triggering of some functions in this way, it is necessary to lock the display when the electronic device is not used. There are many unlocking methods used for unlocking the display of the electronic device, such as sliding an icon along a certain path displayed in the touch sensitive display. However, a new unlocking method may be more convenient in some situations.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a module diagram of an electronic device with a touch sensitive display, in accordance with an exemplary embodiment.

FIG. 2 is a schematic view of the touch sensitive display of the electronic device of FIG. 1 displaying many touch icons, in accordance with an exemplary embodiment.

FIG. 3 is a flowchart of an unlocking method for unlocking the touch sensitive display of the electronic device, in accordance with an exemplary embodiment.

### DETAILED DESCRIPTION

The disclosure is illustrated by way of example and not by way of limitation. It should be noted that references to “an” or “one” embodiment in this disclosure are not necessarily to the same embodiment, and such references mean “at least one”.

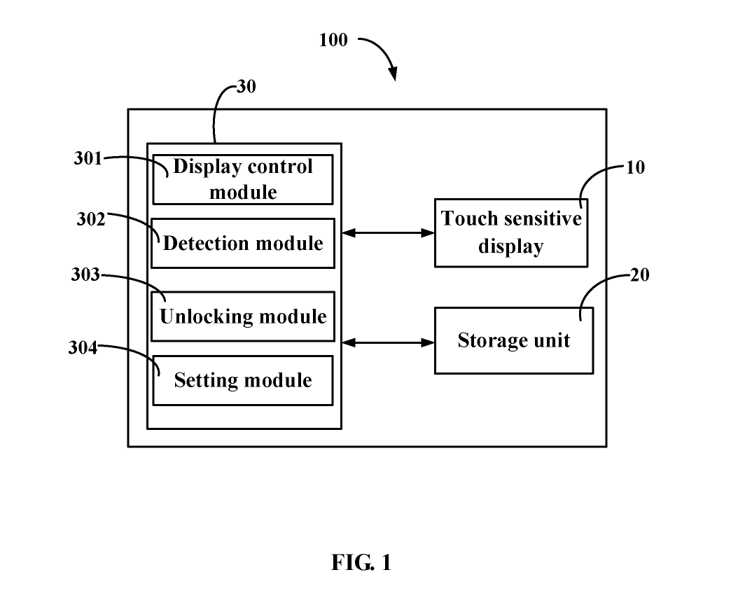

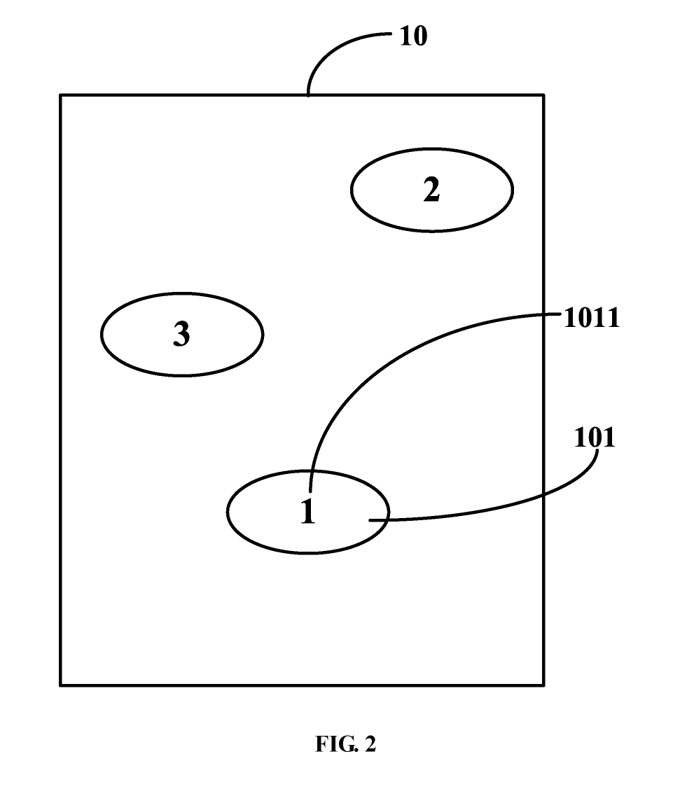

Referring to FIGS. 1-2, an electronic device 100 with a touch sensitive display 10 is provided. The electronic device 100 includes a storage unit 20 and a processing unit 30. The touch sensitive display 10 receives touches from a user. The storage unit 20 stores a table that defines a number of sequences in which one or more icons 101 can be touched. The table below is shown as an example. Arrows in the table indicate an order in which icons 101 are touched. For example, sequence 1 means icons a, c, b, and d to be touched sequentially.

| | |
|---|---|
| sequence 1 | Icon a→icon c→icon b→icon d |
| sequence 2 | Icon b→icon a→icon c |
| . . . | . . . |
| sequence N | Icon b→icon c→icon a→icon b→icon a |

In this embodiment, one icon 101 may be used more than once in a sequence. For example, in the sequence N of the above table, both icons a and b are touched non-sequentially two times each.

The processing unit 30 unlocks the touch sensitive display 10 when a sequence of touches on icons 101 displayed in the display 10 matches one of the sequences stored in the storage unit 20. For example, when the user touches icons a, c, b, and d in succession, the processing unit 30 determines that the sequence in which the user touched icons a, b, c, and d matches the sequence 1, and then unlocks the touch sensitive display 10. The electronic device 100 may be a mobile phone, a camera, and the like which has a touch sensitive display 10.

The processing unit 30 includes a display control module 301, a detection module 302, an unlocking module 303, and a setting module 304.

The display control module 301 is implemented by the processing unit 30 to control some icons 101 to be displayed in the display 10 when the display 10 is in a locked state that can be used to unlock the display 10.

In an embodiment, the display control module 301 may control all the icons 101 to be displayed in the touch sensitive display 10 at the same time, or control the icons 101 to be displayed in the display 10 one by one to prompt the user to unlock the touch sensitive display 10 easily by touching the icons 101 displayed in order on the display 10. Furthermore, the display control module 301 may further control the icons 101 to be displayed in different positions of the display 10. For example, the display control module 301 may control a first-to-be-touched icon 101 to be displayed in an upper left position of the touch sensitive display 10, a second-to-be-touched icon to be displayed in a center of the touch sensitive display 10, and a third-to-be-touched icon 101 to be displayed in a lower right position of the touch sensitive display 10. The display control module 301 may also control an indicium 1011 (for example, such as that shown in FIG. 2, digit 1, 2 and 3) to be displayed with the icon 101, for indicating an order in which the displayed icons 101 are to be touched.

The detection module 302 is implemented by the processing unit 30 to detect whether the sequence in which certain icons of the plurality of icons 101 are touched matches a pre-stored sequence in the table above. In an embodiment, after detecting that an icon 101 of a sequence is touched, the detection module 302 detects whether a next icon 101 of the sequence is touched within a predetermined duration, such as three to five seconds, and the detection module 302 restarts the overall detection if the next icon 101 is not touched within the predetermined duration.

The unlocking module 303 is implemented by the processing unit 30 to unlock the touch sensitive display 10 when the detection module 302 detects that the sequence of touches matches a pre-stored sequence in the table. For example, as shown in FIG. 2, when the detection module 302 detects that the icon 101 with digit 1, the icon 101 with digit 2, and the icon 101 with digit 3 are touched in that order by the user, wherein that sequence matches a pre-stored sequence in the table, the unlocking module 303 unlocks the touch sensitive display 10.

The setting module 304 is implemented by the processing unit 30 to set the pre-stored sequence table. The setting module 304 is further used to set whether some icons 101 by which the display 10 is unlocked are displayed at the same time or one by one, and the positions in which the particular icons 101 of the touch sensitive display 10 are to be displayed.

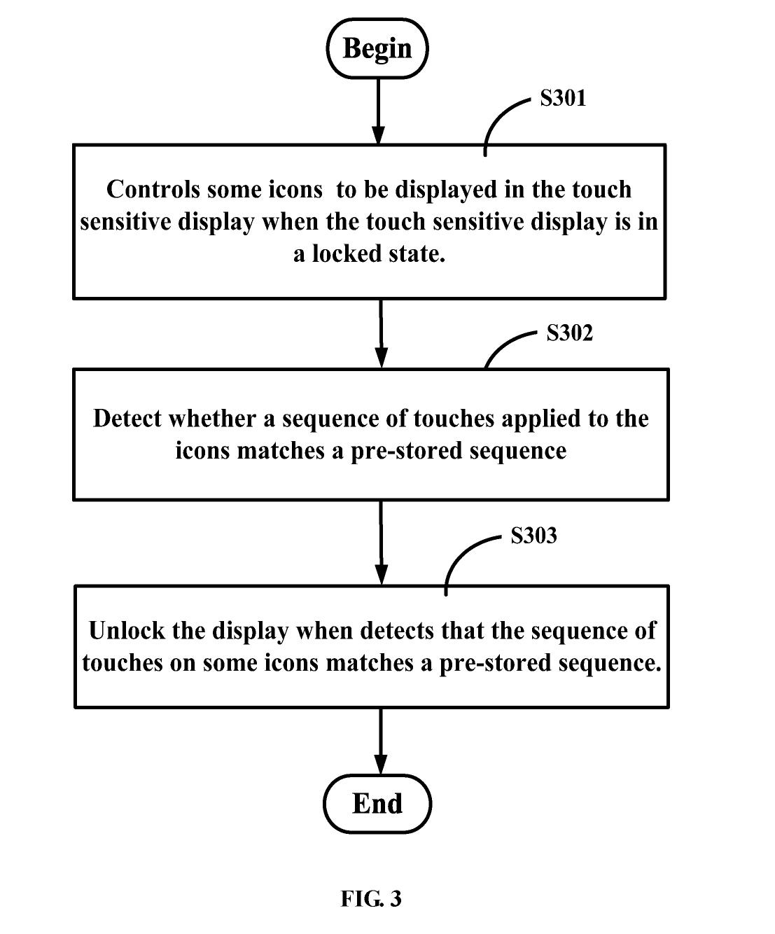

FIG. 3 discloses a flowchart of an unlocking method for unlocking the touch sensitive display 10 of the electronic device 100, in accordance with an exemplary embodiment.

In step S301, the display control module 301 controls a plurality of icons 101 to be displayed in the touch sensitive display 10 when the touch sensitive display is in a locked state.

In step S302, the detection module 302 detects whether any sequence of touches applied to one or more of the plurality of icons 101 matches a pre-stored sequence stored in the table. In an embodiment, upon detecting a touch on an icon 101 of a sequence, the detection module 302 further detects whether a next icon 101 of the sequence is touched within a predetermined duration (such as three to five seconds), and the detection module 302 restarts if the next icon 101 in the sequence is not touched within the predetermined duration.

In step S303, the unlocking module 303 unlocks the display 10 when the detection module 302 detects that the sequence of touches on some icons 101 matches a pre-stored sequence.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. An apparatus comprising:
a touch sensitive display configured to receive touches from a user; and
a processing unit comprising:
a display control module configured to control a plurality of icons to be displayed in the touch sensitive display when the touch sensitive display is in a locked state, which is capable of being used to unlock the touch sensitive display;
a detection module configured to detect whether a sequence in which certain icons of the plurality of icons are touched matches one of at least one predefined sequence; and
an unlocking module configured to unlock the touch sensitive display when the detection module detects that the sequence matches a predefined sequence.

2. The apparatus as described in claim 1, wherein when having detected a first-to-be-touched icon of the predefined sequence is touched, the detection module is further configured to detect whether a next to-be-touched icon of the predefined sequence is touched within a predetermined duration, and the detection module is further configured to restart the overall detection if the next to-be-touched icon is not touched within the predetermined duration.

3. The apparatus as described in claim 2, wherein the display control module is further configured to control an indicium to be displayed with each touch icon when the certain icons are displayed in the touch sensitive display, for indicating an order in which the displayed certain icons will be touched.

4. The apparatus as described in claim 2, wherein the display control module is further configured to control the certain icons to be displayed in the touch sensitive display at the same time.

5. The apparatus as described in claim 2, wherein the display control module is further configured to control the certain touch icons to be displayed in the touch sensitive display one by one.

6. The apparatus as described in claim 1, further comprising a setting module configured to setting the at least one predefined sequence based on inputs from a user.

7. The apparatus as described in claim 6, wherein the setting module is further configured to set whether some icons by which the touch sensitive display is unlocked are displayed at the same time or one by one.

8. An unlocking method for unlocking a touch sensitive display of an apparatus, the method comprising:
controlling a plurality of icons to be displayed in an touch sensitive display when the touch sensitive display is in a locked state, which is capable of being used to unlock the touch sensitive display;
detecting whether a sequence in which certain icons of the plurality of icons are touched matches one of at least one predefined sequence; and
unlocking the touch sensitive display when detecting that the sequence matches a predefined sequence.

9. The unlocking method as described in claim 8, wherein the step “detecting whether a sequence in which certain icons of the plurality of icons are touched matches one of at least one predefined sequence” further comprises:
when having detected a first-to-be-touched icon of the predefined sequence is touched, further detecting whether a next to-be-touched icon of the predefined sequence is touched within a predetermined duration, and restarting the overall detection if the next to-be-touched icon is not touched within the predetermined duration.

10. The unlocking method as described in claim 9, wherein the certain icons to be displayed in the touch sensitive are display at the same time.

11. The unlocking method as described in claim 9, wherein the certain icons to be displayed on the touch sensitive are display one by one.
